(19) United States
(12) Patent Application Publication
(10) Pub. No.: US 2026/0104202 A1
(43) Pub. Date: Apr. 16, 2026

(54) CO2 PROCESSING INSTALLATION USING A HIGH-FLOW CO2 GAS SOURCE AND WOOD DRYING RESOURCES IN A CO2 ATMOSPHERE

(71) Applicant: WAYS SAS, Samois-sur-Seine (FR)

(72) Inventors: Yann RAOULT, Samois sur Seine (FR); Guillaume CARMASSI, Rodez (FR)

(73) Assignee: WAYS SAS, Samois-sur-Seine (FR)

(21) Appl. No.: 19/145,609

(22) PCT Filed: Sep. 11, 2023
(86) PCT No.: PCT/EP2023/074864

§ 371 Date: Jul. 3, 2025

(30) Foreign Application Priority Data
Jan. 5, 2023 (FR) FR2300130
Jan. 5, 2023 (FR) FR2300136

(51) Int. Cl. F26B 25/22; F26B 21/33; F26B 21/35; F26B 21/37; F26B 21/40

(52) U.S. Cl. CPC F26B 25/22; F26B 21/333; F26B 21/35; F26B 21/37; F26B 21/40; F26B 2210/16

(57) ABSTRACT

A facility for processing CO2 from a high-output CO2 source includes at least one CO2 distribution system having a supply circuit comprising an inlet end connected to the high-output CO2 source for collecting and storing the CO2, and an outlet end; drying means for drying in a CO2 atmosphere, connected to the CO2 distribution system, and configured to process said CO2 thus distributed during a drying operation and comprising storage means connected on the one hand to the outlet end of the supply circuit and on the other hand to the drying means, said storage means being configured to temporarily store the CO2 from the high-output CO2 source for later processing of said CO2.

This invention relates to a CO2 processing installation from a high-flow CO2 source, and more particularly to the adaptation of a high-flow CO2 gas source to supply wood drying modules capable of using and storing CO2 directly in the gas state.

CO2 processing refers to all types of collection, use and sequestration of CO2.

A great deal of progress has been made in the field of CO2 sequestration. However, the purification, liquefaction and storage of CO2 are still required for many CO2 use and sequestration technologies, and transport and distribution methods remain limited both in terms of purification of said CO2 and adaptability to very high flow rates. Biogenic CO2 produced during methanisation processes or, even more complex still, coming out of factory stacks, which usually generate a very high emission rate, makes it necessary to release a large part of this flow of greenhouse gas emissions, including CO2, into the atmosphere. In the case of the high-flow source of CO2 from methanisation, the biogenic CO2 represents around 98% of the gaseous effluent volume. In the case of a high-flow CO2 source from an industrial stack (emissions from an industrial boiler, for example), the proportion of CO2 may only represent 20% of the effluent gas.

CO2 sequestration systems are known, such as those taught by the Applicant in document W02020127026, using wood drying cells in a CO2. atmosphere. However, those systems have the major disadvantage of not being able to handle reduced CO2 flows, combined with high costs that make it difficult to implement multiple cells to handle a high flow of CO2. The supply of liquefied CO2 (in the form of cylinders, for example) limits existing CO2 sequestration systems in terms of volume and cost, making industrial scale-up with the management of high CO2 flows very difficult.

CO2 sources with gas distribution systems are also known, such as methanisation centres with biomethane purification and distribution systems comprising a distribution outlet, also known as “off-gas”, dedicated to the evacuation of a biogenic CO2 of which the concentration by weight in the gas mixture is greater than 98%. The disadvantage of such systems is that they are not suitable for sequestration systems based on wood drying in a CO2 atmosphere where the CO2 output exceeds 40 Nm3/h. The interface between a biogenic CO2 off-gas from known gas distribution systems and the entry into sequestration systems by drying wood in a CO2 atmosphere does not make it possible to provide controlled and regulated injection in conditions that guarantee controlled drying cycles with a sufficient and secure supply.

These systems also have the disadvantage of not being able to supply CO2 on demand to the drying systems, sometimes continuously, sometimes occasionally, during a drying cycle (due to CO2 trapping), and requiring interfacing and programmed management of CO2 flows between the high-flow CO2 source and the CO2 sequestration system by wood drying in a CO2 atmosphere.

High-flow CO2 is defined here as any CO2 flow in excess of 40 Nm3/h.

The term CO2 sequestration here means any substitution, chemical reaction between CO2/wood polymers/water or complexation or stable accumulation of CO2. or carbonation of wood or of the water contained in the wood with compounds such as wood to be dried or similar receiving material.

Wood means any ligno-cellulosic material or similar compound capable of sequestering CO2.

By way of a non-limiting example, the high flow CO2 source may be a methanisation plant allowing biogenic CO2 to be exploited, an industrial plant such as a boiler releasing a mixture of gases containing CO2 into the atmosphere, or any other industrial complex of which the CO2 production allows any CO2 flow greater than 40 Nm3/h.

The aim of the present invention is to overcome these problems.

The invention relates to a plant for processing CO2 from a high flow CO2 source comprising:
at least one CO2 distribution system having a supply circuit comprising an inlet end connected to the high-flow CO2 source for collecting and storing CO2 from the CO2 source, and an outlet end for supplying the drying resources in a CO2 atmosphere
drying resources in a CO2 atmosphere connected to the CO2 distribution system and configured to process said CO2 thus distributed during a wood drying operation;

According to a general definition of the invention, the CO2 distribution system further comprises storage resources connected on the one hand to the outlet end of the supply circuit and, on the other hand, to the drying resources in a CO2 atmosphere, said storage resources being configured to temporarily store the CO2 from the high flow CO2 source for subsequent processing of said CO2.

Advantageously, the installation according to the invention makes it possible to control the CO2 distribution while allowing the sequencing of the drying operations for CO2 sequestration. The storage resources make it possible to supply the drying resources with CO2 when the supply of CO2 from the high flow CO2 source is unavailable or when the available flow from the CO2 source is much greater than the specific drying resource needs, while making it possible to multiply the number of drying resources in a CO2 atmosphere that can be used for the same installation. This scale-up makes it possible to handle high-flow CO2. The storage resources can also be used as a supply source for any other CO2 purification or distribution system for the CO2 collected in gaseous form and present in the gas mixture thus stored.

Advantageously, the distribution system according to the invention also allows the CO2 to be processed without affecting the operation of the high flow CO2 source.

In addition, the installation makes it possible to control the CO2 supply parameters to the drying resource while limiting the electricity required to guarantee the operation of multiple drying resources.

In practice, the drying resources in a CO2 atmosphere comprise at least two drying modules configured to sequester the used CO2 in wood.

According to one embodiment, the multiple drying modules are configured in parallel.

According to an alternative embodiment, the multiple drying modules are configured in series.

According to an alternative embodiment, the multiple drying modules are configured in series and in parallel.

According to one embodiment, the CO2 storage resources comprise at least one buffer tank configured to temporarily store the CO2 from the high flow CO2 source by supply through a solenoid supply valve, and to act as a secondary CO2 supply source to supply the CO2 atmosphere drying modules or any other CO2 use module.

According to one embodiment, the CO2 distribution system further comprises booster resources connected to the high flow CO2 source outlet, configured to allow the collection of CO2 from the high flow CO2 source, control the CO2 pressure and flow in the supply circuit.

According to one embodiment, the CO2 distribution system also comprises pressure sensor resources located at the high flow CO2 source outlet and before the solenoid valve supplying the buffer tank.

According to one embodiment, the CO2 distribution system also comprises gas flow measurement resources configured to measure and record the flow rate of the CO2 flowing through the supply circuit.

In practice, the distribution system also comprises CO2/CH4 measurement resources configured to measure the proportion of CO2 or CH4 relative to the overall flow of gas introduced into the system in the circulating gas mixture.

By way of example, the booster resources make it possible to interface with the high-flow CO2 supply source and the establishment during a CO2 draw off phase of a flow speed in the gas mixture flow duct of between 1 and 15 metres per second.

In practice, the booster resources provide a pressure of between 0 and −50 mbar during the CO2 draw off phases.

Advantageously, this invention uses CO2 in gas form directly, allowing it to be used directly on the same site that discharges said CO2 from its industrial stacks or other high-flow CO2 source, and to do so continuously without disrupting the production and operation of the CO2 source.

In practice, each CO2 atmosphere drying module comprises:—a drying chamber comprising at least one hollow cylindrical drying tube of suitable diameter and length for drying wood of selected dimensions,
CO2 supply resources for the injection of the CO2 gas into the drying chamber;
circulation resources;
heating resources to warm the circulating CO2;
gas circulation resources making it possible to force the circulation of CO2 from one end of the drying chamber to the other in a closed circuit in the chamber length direction, with injection into and extraction from the cylinder advantageously positioned at the ends of the cylindrical drying chamber, and the renewal of the atmosphere inside the drying chamber, and comprising a flow reversal module configured to allow the circulation of CO2 in a first flow direction in the drying chamber and in a second flow direction in said chamber, and capable of evening out the thermal distribution in said drying chamber;
CO2 recycling resources configured to allow the separation of the water vapour and CO2 gas present in the atmosphere extracted from the chamber during drying;
metrology resources to measure variations in the physical parameters of the drying module during heating;
the CO2 supply resources; and
a computerised control system to control the supply, circulation, heating and recycling resources according to programmes, set point values and drying times appropriate to the required quality of the dried wood, and processing resources to measure, compare and readjust the operating parameters to the set point values if drifts occur.

Advantageously, the use of a drying module in accordance with the invention allows the sequestration/trapping of a maximum quantity of CO2 of the order of 250 kg per cubic metre of wood.

The Applicant has observed that the installation according to the invention allows a maximum volume of CO2 processed per drying cycle per cell of 125 m3 of CO2 injected at atmospheric pressure.

In addition, the computerised control system is equipped with an application programming interface (API) configured to:
Acquire metrology data and parameters of the wood to be dried by measuring the metrology resources;
Activate the CO2 supply resources configured to saturate the drying chamber with CO2;
Check that the CO2 saturation in the circulating gas mixture is sufficient to start a drying cycle by checking the CO2/CH4 measuring resources in the extraction duct;
Activate heating resources to adjust the humidity of the wood by heating when a sufficient measured CO2 saturation is reached.
If the humidity of the wood exceeds 30%, heat with a temperature limit according to a first set point temperature T1, according to a selected temperature gradient G1 in order to extract the free water from the wood to be dried and activate the circulation resources;
   If the humidity of the wood is less than 30%, heat with a temperature limit according to a first set point temperature T2, according to a selected temperature gradient G2 in order to extract the bound water from the wood to be dried and activate the circulation resources;
   Stabilise the temperature of the CO2 circulating in the drying chamber in a first phase when a humidity of less than or equal to 30% is measured, activate the recycling resources and subsequently increase the temperature of the CO2 circulating in the drying chamber in a second phase until the measured humidity of the wood reaches a selected intermediate target value Hi, the heating resources being activated so that reheating is carried out with a limit temperature defined by a second set point temperature T2 of 120° C. according to a selected temperature gradient G2, and depending on the specific drying profile of the wood to be dried making it possible to extract the bound water from the wood to be dried;
   Deactivate the recycling resources and modulate the heating resource activity to reduce the heating chamber temperature in a first phase, to a third stabilisation set point temperature T3 selected according to a temperature gradient G3, when the average humidity of the wood measured using the wood humidity measurement resources reaches the selected intermediate target value Hi, unless one of the measured humidity values of the wood is greater than Hi+1%, said set point temperature T3 being maintained for a selected period of time until the measured humidity value of the wood greater than Hi+1% is stable and within a range of values less than Hi+1%.
Deactivate the heating resources to reduce the heating chamber temperature in a second phase when the measured average humidity of the wood reaches the final target humidity value Hc.

Advantageously, the precise control of the drying cycle based mainly on the hygrometry values also makes it possible to limit the temperature rise and the heat energy required for the drying cycle, thereby allowing optimised energy consumption by the heating resource and by the drying cycle.

According to one embodiment of the invention, the drying module CO2 recycling resources are of the heat exchanger type comprising at least one cooling battery.

In practice, the CO2 recycling resources comprise at least one cooling battery to be configured in series to gradually extract the water from the gas mixture, each cooling battery being capable of extracting a selected percentage of water from said gas mixture.

The Applicant observed that a structure in series made it possible to control and limit the hygrometry in the drying chamber and thus prevent the saturation of the recycling resources, also making it possible to limit the duration of each drying cycle and thus limit the energy consumption required during each drying cycle.

According to a specific embodiment of the invention, the installation also comprises an additional photovoltaic type power supply module used to temporarily offset the installation's energy demand, mainly but not exclusively when the number of drying modules is large.

For example, each CO2 atmosphere drying module comprises a drying chamber of a volume of at least 10 m3 saturable in CO2.

Advantageously, the system according to the invention allows a controlled distribution of CO2 to the CO2 sequestration systems that is independent of the availability of CO2 at the high-flow CO2 source.

Other advantages and characteristics of the invention will appear on examination of the description and drawings in which:

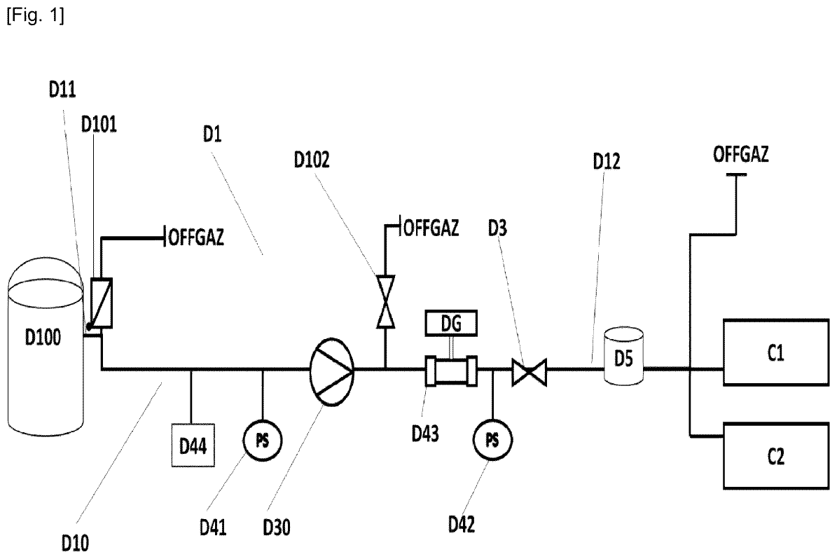

FIG. 1 schematically represents the CO2 processing installation compliant with the invention;

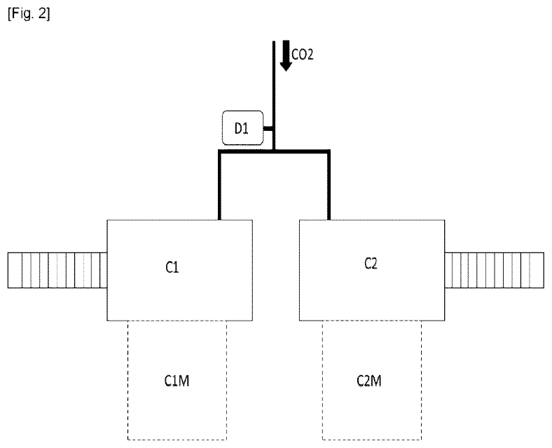

FIG. 2 schematically represents an embodiment of the invention comprising two drying modules compliant with the invention;

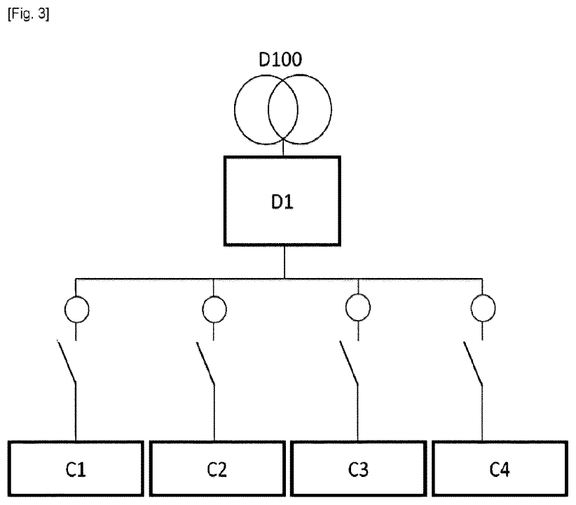

FIG. 3 schematically represents an embodiment of the invention comprising four drying modules compliant with the invention;

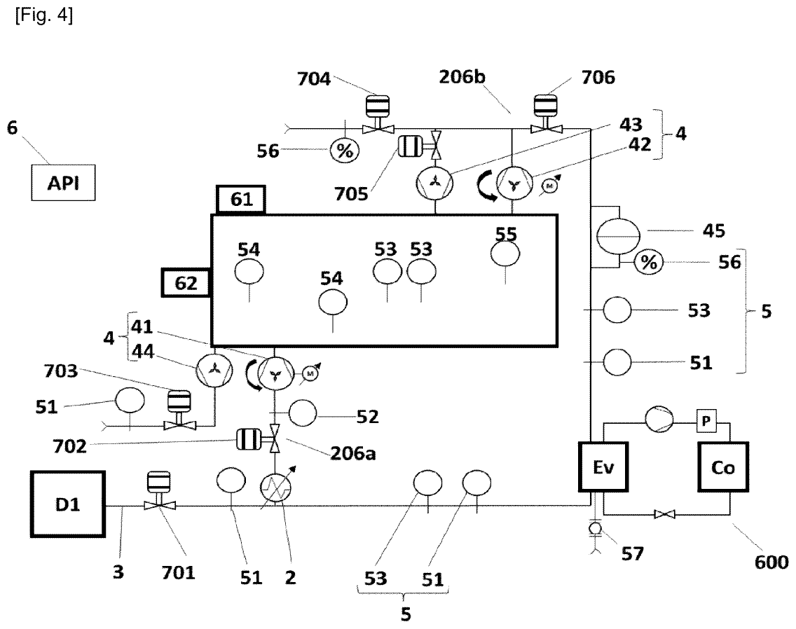

FIG. 4 schematically represents a wood drying module compliant with the invention; and

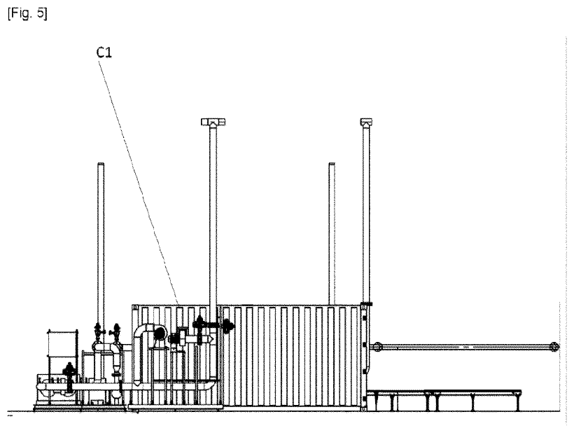

FIG. 5 schematically represents a drying chamber compliant with the invention.

With reference to FIG. 1, the CO2 processing installation from a high-flow CO2 source D100 compliant with the invention comprises at least one CO2 distribution system D1 having a supply circuit D10 comprising an inlet end D11 connected to the high-flow CO2 source D100, and an outlet end D12, said supply circuit D10 being configured to collect CO2 from the high-flow CO2 source D100, to store the CO2 gas thus collected, and to supply the CO2 atmosphere drying resources.

The distribution system D1 further comprises storage resources connected to an outlet end D12 of the supply circuit D10 and to the CO2 atmosphere drying resources C1, C2, said storage resources being configured to temporarily store CO2 from the high flow CO2 source D100.

“Temporary storage” means any CO2 storage for subsequent use according to the selected parameters. These uses belong to the unit formed by purification of the CO2, distribution of the CO2, processing of the CO2, drying in a CO2 atmosphere or any other similar use of CO2 gas, but are not limited to them.

In addition, the drying resources have drying modules C1, C2, each module being configured to carry out drying cycles in a CO2 atmosphere.

According to one embodiment of the invention, the storage resources comprise at least one buffer tank D5, connected to the outlet end D12 of the supply circuit D10 and to the CO2 atmosphere drying modules C1, C2, said buffer tank D5 being configured to temporarily store the CO2 from the high flow CO2 source D100 by supply through a supply solenoid valve D3 and to serve as a secondary CO2 supply source for the CO2 atmosphere drying modules C1, C2 or any other CO2 use module.

Advantageously, the buffer tank D5 allows CO2 to be supplied to the drying modules C1, C2, depending on the drying cycle of each drying module C1, C2, and thus allows sequential drying while avoiding a shortage of CO2, and avoiding degassing part of the available CO2 to the atmosphere.

According to one embodiment of the invention, the buffer tank D5 is supplied with CO2 in a sequence comprising:
injection of the CO2 from the buffer tank D5 to at least one drying module C1, C2;
halt of the injection of the CO2 from the buffer tank D5 to at least one drying module C1, C2;
injection of the CO2 from the distribution system D1 to the buffer tank D5 to maintain a maximum fill volume by opening the solenoid supply valve D3; and
halt of the CO2 injection from the distribution system D1 to the buffer tank D5 is when the buffer tank is filled to maximum capacity.

The Applicant has observed that the CO2 storage resources, such as the buffer tank D5 in use, make it possible to decorrelate the high flow CO2 source D100 supply parameters from the supply to the drying systems C1, C2, while still using the CO2 in gas form without the need to liquefy it for use.

The distribution system D1 according to the invention also comprises pressure sensor resources D41, D42 placed at the outlet of a high flow CO2 source D100 and before the solenoid valve D3 supplying the buffer tank D5.

In practice, the pressure sensor resources D41, D42 are used to measure the negative pressure upstream of the booster resources D30 and the pressure downstream of the booster resources to make sure the pressure in the supply circuit D1 allows the CO2 to circulate in optimum conditions.

In addition, the booster resources D30 are connected to the output of the high-flow CO2 source D100, and are configured to control the pressure and flow of CO2 in the supply circuit D1 so that the CO2 can circulate therein.

The high-flow CO2 sources D100 such as methanisation tanks, have an outlet pressure that does not allow the CO2 to circulate at a sufficient rate to be injected effectively into drying modules C1, C2.

In practice, the booster resources D30 have an internal control system that takes into account the C2 circulation parameters (pressure, speed) in the C1 and C2 drying systems and the availability of the high flow CO2 source D100.

According to one embodiment, the distribution system D1 of the installation according to the invention comprises gas flow measurement resources D43 configured to measure and record the flow of CO2 circulating in the supply circuit D10 in order to retro-control the operation of the booster resources D30 so as to maintain a circulation speed and a pressure of the gas mixture in the supply circuit D10.

By way of a non-limiting example, the gas mixture circulation speed is between 1 and 15 metres per second during the CO2 drawing off phases.

By way of a non-limiting example, the booster resources D3 provide a pressure of between 0 and −50 mbar during the CO2 drawing off phases.

CO2 drawing off phase means any phase designed to circulate the CO2 from the high flow CO2 source D100 to the drying resources.

According to a specific embodiment of the invention, the distribution system D1 comprises CO2/CH4 measuring resources D44, configured to measure the proportion of CO2 relative to the total volume of circulating gas and the proportion of circulating CH4 in order to maintain a selected CO2 saturation in the drying chamber.

Advantageously, depending on the CO2 source, measuring resources may be set up to monitor and control other gases present in the gas mixture used as the CO2 source. For example, in the case of a biogenic CO2 source such as an anaerobic digestion plant, this prevents the methane concentration from exceeding a critical explosion threshold. The critical explosion threshold is defined as the concentration of methane in the circulating gas being sufficient to cause damage to the supply circuit D10 and the drying systems C1, C2.

According to a specific embodiment, when the high flow CO2 source D100 is an industrial stack, a CO2 concentration module is included between the high flow CO2 source D100 and the buffer tank D5, and configured to concentrate the CO2 in the gas mixture collected for use in the installation according to the invention up to a selected weight percentage relative to the selected total gas flow.

By way of a non-limiting example, the selected weight percentage is between 60 and 98%.

The distribution system D1 according to the invention also comprises an extraction mechanism 102 comprising a duct, the end of which is open to the atmosphere, and a solenoid valve which can be opened to degas the distribution system D1 when at least one gas mixture circulation parameter exceeds a system tolerance threshold. For example, when the methane concentration exceeds a critical explosion threshold.

With reference to FIGS. 2 to 3, the processing installation according to the invention also comprises CO2 atmosphere drying resources connected to the CO2 distribution system D1 and configured to process the CO2 during the drying operation.

In practice, the drying resources comprise at least two CO2 atmosphere drying modules C1, C2 connected to said CO2 distribution system D1.

According to a specific embodiment of the invention, each distribution system D1 allows the supply of multiple drying modules C1, C2, C3, C4.

By way of a non-limiting example, a CO2 processing plant according to the invention may comprise multiple distribution systems D1, each system being connected to multiple drying modules C1, C2, C3, C4, making it possible to obtain a solution that can be scaled up for the sequestration of large quantities of CO2.

With reference to FIGS. 4 and 5, the installation's drying module C1, C2 according to the invention comprises several functional groupings including a heating chamber 1 comprising at least one drying tube into which the wood to be dried is introduced, heating resources 2, CO2 supply resources 3, gas circulation resources 4 allowing the renewal of the atmosphere inside the drying chamber 1, several metrology measurement units forming metrology resources 5, and finally a computerised control system 6 equipped with an application programming interface (API).

The drying module C1, C2 has a drying chamber 1 consisting of one or more hollow cylindrical drying tubes into which the wood to be dried is entered.

The drying chamber is connected to the heating resource 2 by an inlet duct 206a, and has an outlet duct 206b configured to discharge the CO2 gas mixture from said drying chamber 1.

In practice, the inlet duct 206a is placed at a first end of drying chamber 1 and the outlet duct 206b at a second end of drying chamber 1 so as to allow longitudinal circulation of the CO2 gas mixture relative to the wood to be dried. By way of a non-limiting example, drying chamber 1 comprises a closed, heat-insulated tube with internal atmospheric recirculation.

According to a specific embodiment of the invention, drying chamber 1 comprises a minimum volume of 10 m3 that is saturable with CO2.

According to one embodiment, drying chamber 1 according to the invention comprises metrology resources 5 configured to measure parameters belonging to the group formed by the humidity of the wood to be dried, the humidity in drying chamber 1, the temperature of the wood to be dried, the temperature in drying chamber 1, and the pressure in drying chamber 1.

According to one embodiment, drying chamber 1 according to the invention comprises at least one temperature and humidity measurement sensor 53 in the drying chamber.

By way of a non-limiting example, drying chamber 1 comprises two temperature and humidity measurement sensors 53 in the drying chamber

According to one embodiment, drying chamber 1 according to the invention comprises at least one humidity sensor 54 to measure the humidity of the wood to be dried.

By way of a non-limiting example, drying chamber 1 comprises two humidity sensors 54 to measure the humidity of the wood to be dried.

In practice, drying chamber 1 also comprises a control box 61 configured to receive and process the data recorded by the sensors 54 measuring the humidity of the wood to be dried.

According to one embodiment, drying chamber 1 according to the invention also comprises a pressure measurement sensor 55 in said drying chamber 1, allowing the emergency discharge of part of the atmosphere contained in drying chamber 1 if a critical pressure occurs therein.

In practice, each metrology measurement includes a set point value or a group of set point values to be respected specific to each species or application of the wood to be dried.

In practice, the critical pressure may be 1.5 bar.

Drying chamber 1 according to the invention also comprises door closure sensors 62, configured to detect the closure status of the doors through which the wood to be dried is inserted.

By way of a non-limiting example, the drying chamber 1 is 5.5 m long with a circulation diameter of 2.4 m, cylindrical or virtually cylindrical in shape and enclosed in a marine container insulated with 60 mm thick wood wool panels. This box is connected from one end to the other by a heat-insulated pipe, a heating system 2 and four centrifugal circulation fans capable of withstanding temperatures of up to 250° C.

The drying module C1, C2 furthermore comprises operating means C1M, C2M configured to operate and control the drying in each drying module C1, C2 and corresponding to any resource placed outside the drying chamber 1 allowing the operation thereof.

The drying module C1, C2 comprises CO2 supply resources 3 configured to control the injection of the CO2 gas mixture from the CO2 storage resources of distribution circuit D1.

The CO2 supply resources 3 comprise a duct connected on the one hand to the D1 distribution system storage resources, and on the other hand to the heating resources 2, said duct being equipped with a solenoid valve 701 to control the injection of the CO2 into the drying module C1, C2.

In practice, when the solenoid valve 701 is open, a command is sent to the high-flow CO2 source D100 to supply CO2 to the distribution system D1.

In practice, the CO2 supply resources 3 also comprise metrology resources 5 configured to measure parameters belonging to the group formed by the flow of the injected circulating CO2 gas mixture and the temperature of the injected circulating CO2 gas mixture.

According to one embodiment, the CO2 supply resources 3 comprise at least one sensor to measure the temperature and circulating flow 51.

According to another alternative embodiment, the CO2 supply resources 3 comprise at least one so-called “direct” CO2 supply module, and a so-called “recycled” CO2 supply module connected to the drying module C1, C2 by a connection system (30, 31) to a CO2 source comprising at least one solenoid valve (EVC1, EVC2) configured to allow the injection/stopping of the injection of CO2 into the drying module C1, C2.

Direct CO2 means CO2 from a source of high-flow CO2 in the form of a gas that has not been purified on exiting the off-gas or industrial stack and the gas mixture of which containing CO2 is used directly by the drying module (301) without any change in the phase of the CO2.

Recycled CO2 means CO2 from a CO2 supply from a high-flow CO2 source, such as CO2 in cylinders and liquefied.

In practice, the CO2 supply resources (3) consist of at least one CO2 injection system using CO2 from the distribution system D1 towards the heating resources 2.

The drying module C1, C2 furthermore comprises heating resources 2 connected to the CO2 supply resources 3 on the one hand, and to the drying chamber 1 on the other hand by an inlet duct 206a.

In practice, heating resources 2 are of the immersion heater type and more particularly of the “in-line electric heater” type.

By way of example, the immersion heater has a power rating of 90 kW, and comprises an inlet through which the gases to be heated enter, an open cylindrical or virtually cylindrical steel duct into which an immersion heater is inserted, and finally a second outlet opening for the gases thus heated. The immersion heater furthermore comprises a thermostat for regulating the temperature of the immersion heater.

According to a first embodiment, the drying resources 1 consist of a plurality of drying modules C1, C2, C3, C4 connected to heating resources 2 common to several drying modules C1, C2, C3, C4.

According to an alternative embodiment, the drying resources 1 consist of a plurality of drying modules C1, C2, C3, C4 each connected to individual heating resources 2.

The inlet duct 206a comprises a solenoid valve 702 configured to control the injection of the CO2 gas mixture into the drying chamber 1, in addition to gas circulation resources 4.

In practice, the gas circulation resources 4 of the inlet duct 206a comprise at least one fan 41 capable of operating bilaterally in two gas mixture circulation directions, i.e. towards the drying chamber 1, and from the drying chamber 1.

Alternatively, the inlet duct 206a comprises at least two ducts connected to the drying chamber 1, each duct comprising at least one fan 41. These fans 41 are each configured to operate in one direction of circulation, i.e. at least one fan towards drying chamber 1 and one fan from the drying chamber into the inlet duct 206a.

The heating resources 2 are also connected to an outlet duct 206b connecting an outlet end of the drying chamber 1 to said heating resources 2, and forming a closed loop circulation duct for the CO2 gas mixture.

The outlet duct 206b comprises a solenoid valve 706 configured to control the discharge of the CO2 gas mixture into the drying chamber 1, in addition to gas circulation resources 4.

In practice, the gas circulation resources 4 of outlet duct 206b comprise at least one fan 42 capable of operating bilaterally in two directions of circulation of the gas mixture, i.e. towards drying chamber 1, and from drying chamber 1.

Alternatively, the outlet duct 206b comprises at least two ducts connected to the drying chamber 1, each duct comprising at least one fan 42. These fans 42 are each configured to operate in one direction of circulation, i.e. at least one fan towards the drying chamber 1 and one fan from the drying chamber towards the heating resource 2.

By way of a non-limiting example, the circulation resources 4 of the fan type 41, 42, are of the medium-pressure, single-suction centrifugal fan type with sheet steel casing and impeller, said fan comprising an impeller with forward-inclined blades made of galvanised sheet steel, the fan 51 being capable of withstanding a maximum temperature of the air or CO2 to be transported of −20° C. to 250° C.

The circulation resources 4 of the inlet duct 206a combined with the circulation resources 4 of the outlet duct 206b form a flow reversal module capable of allowing the circulation of the CO2 gas mixture from the heating resource 2 to the drying chamber 1 in a first direction of operation and from the drying chamber 1 to the heating resource 2 in a second direction of operation, and thus force the circulation of the CO2 gas mixture in a closed circuit through the drying chamber 1 in two directions.

Advantageously, the alternative circulation of the CO2 in the inlet duct 206a and outlet duct 206b in two directions allows the CO2 to circulate longitudinally in the direction of the drying chamber 1 length, with injection and extraction positioned advantageously at the ends of the drying chamber 1, thereby maintaining a uniform temperature of the gas mixture in the drying chamber 1 and thereby allowing the drying of the wood and uniform processing of the CO2 in the wood.

The Applicant has observed that the use of the flow reversal module and more specifically the circulation of CO2 longitudinally in the drying chamber 1 in an alternative manner makes it possible to limit the presence of liquid state water inside the drying chamber 1, and thus make the use of a tilted drying chamber and a goose-neck type removal system to remove the liquid water that may accumulate at the bottom of the drying chamber 1 optional.

In addition, such uniform drying makes it possible to achieve tangential shrinkage of less than 5% and radial shrinkage of less than 4%, in contrast to an average standard shrinkage of around 10 to 15% with conventional drying methods. The invention also drastically limits the warping of the lumber and, in particular, prevents the knots in the wood from distorting during drying. This reduced warping of the wood during drying can represent savings in material of up to 20%, depending on the application.

In practice, the fans 41, 42 of the inlet duct 206a and the outlet duct 206b are coupled to frequency inverters that advantageously enable the speed of rotation to be reduced depending on the species of wood to be dried and therefore the flow rate of the circulating gas mixture depending on the humidity level of the wood and the temperature of the circulating gas mixture, and thus optimise drying uniformity.

The outlet duct 206b furthermore comprises a bypass 45 to draw off the circulating gas mixture and including CO2/CH4 measurement resources 56 configured to measure the proportion of CO2 relative to the total volume of circulating gas and the proportion of CH4 circulating during the CO2 drying phase of the drying module C1, C2 and thus to check the CO2 saturation throughout the circuit of the drying module C1, C2.

Advantageously, monitoring the CO2/CH4 in the gas mixture during drying makes it possible to record changes in the concentration of the different compounds in the circulating gas mixture and thus to be able to adjust the operation of the drying module 1, but also to ensure the safety of the drying module C1, C2 if a drastic increase in the quantity of CH4 occurs.

In practice, if the quantity of CH4 in the circulating gas mixture during drying exceeds 3.5%, the C1, C2 drying module is immediately emptied.

The outlet duct 206b also comprises metrology resources 5 configured to measure parameters belonging to the group formed by the flow of the injected circulating CO2 gas mixture, the temperature of the injected circulating CO2 gas mixture and the humidity of the circulating gas mixture.

According to one embodiment, the outlet duct 206b comprises at least one sensor to measure the temperature and circulating flow rate 51.

By way of a non-limiting example, the outlet duct 206b comprises at least one sensor to measure the temperature and the circulating flow rate 51 placed upstream and a sensor to measure the temperature and the circulating flow rate 51 placed downstream from the CO2 recycling resource 600.

According to one embodiment, the outlet duct 206b comprises at least one sensor to measure the temperature and the humidity 53.

By way of a non-limiting example, the outlet duct 206b comprises at least one sensor to measure the temperature and the humidity 53 placed upstream and a sensor to measure the temperature and the humidity 53 placed downstream from the CO2 recycling resource 600.

In practice, the outlet duct 206b comprises at least one sensor to measure the temperature and humidity 53 placed upstream, and one sensor to measure the temperature and humidity 53 placed downstream of the CO2 recycling resource 600, and at least one sensor to measure the temperature and the circulating flow rate 51 placed upstream and one sensor to measure the temperature and the circulating flow rate 51 placed downstream of the CO2 recycling resource 600.

Advantageously, such an arrangement allows to monitor the composition of the circulating gas mixture, but also the activity of the CO2 recycling resource 600 and their modulation.

The drying module C1, C2 according to the invention also comprises CO2 recycling resources 600 placed at the outlet duct 206b used to separate the water vapour and the CO2 gas present in the atmosphere extracted from the chamber 1 during drying in order to be able to eliminate the water while recovering the CO2 for storage or direct reuse in the installation.

By way of a non-limiting example, condensation-type recycling resources 600 are used, reducing the temperature of the binary water vapour/CO2 gas mixture extracted from the drying chamber 1 to a selected temperature, allowing the condensation of the water in the mixture which is subsequently recovered by gravity in liquid form and disposed of. In practice, the recycling resources 600 allow the drying of the internal atmosphere extracted from the drying chamber 1 via thermal condensation of the water vapour by cooling on at least one heat exchanger equipped with at least one cooling battery; several cooling batteries configured in series can advantageously be used to increase the dehumidification capacity of each drying module C1, C2. The system therefore allows the dehydrated atmosphere to be re-injected into the drying chamber 1.

In practice, each heat exchanger comprises at least one evaporator EV and at least one condenser CO.

According to one embodiment of the invention, the recycling resource 600 heat exchanger is only active when the humidity of the circulating gas mixture is between two threshold values.

In practice, the CO2 recycling resource 600 heat exchanger is only active during the drying phase, and when the measured humidity of the circulating gas mixture is between a maximum threshold value and a minimum threshold value.

By way of an example, the humidity threshold values in the drying chamber 1 are 20% for the minimum threshold and 100% for the maximum threshold.

According to one embodiment of the invention, the recycling resources 600 comprise a system of the heat exchanger type comprising at least two cooling batteries configured in series to gradually extract the water from the gas mixture, each cooling battery being capable of extracting a selected percentage of water from said gas mixture.

Advantageously, a series of cooling batteries can be used to limit the humidity in the drying chamber 1, thereby limiting the duration of the drying cycle, solving the performance problem of a conventional heat exchanger when the humidity is higher than the critical operating value, and thereby reducing the duration of each cycle, causing each drying module C1, C2 to operate for a shorter period of time and limiting the associated energy costs.

According to one embodiment, the recycling resources 600 furthermore comprise a discharge outlet configured to discharge the condensed water or condensate, said discharge outlet incorporating a water flow meter 57.

The water flow meter 57 is configured to record the discharge flow rate of the water to be eliminated, and thus makes it possible to correlate the quantity of eliminated water to the difference between the initial and final humidity of the wood for a drying cycle.

By way of example, maintaining the humidity in the drying chamber 1 below a selected value makes it possible to shorten the drying cycle for which the CO2 circulation resources 213a, 213b in the drying modules C1, C2 may account for 5 to 20% of the energy costs.

Advantageously, the recycling resources 600 make it possible to control the humidity of the gas mixture and thus to control the quality of the wood drying, thereby optimising the drying process and the quality of the material obtained while limiting energy costs and maintaining a low temperature difference between the CO2 coming out of heating resource 2 and coming from the recirculation module 206c.

In practice, the CO2 gas recovered by the recycling resource 600 can be stored in the distribution system D1 storage resources, or re-injected directly into the drying chamber 1.

According to a specific embodiment of the invention, the drying chamber 1 comprises at least one discharge circuit which is followed by a so-called “breather” duct comprising at least one solenoid breather valve 704, 705 for the drying chamber 1, allowing air from outside the installation to be injected into the drying chamber 1 and the gas mixture contained in said drying chamber 1 to be discharged.

The discharge circuit furthermore comprises fan-type 43 circulation resources 4, as well as CO2/CH4 measurement resources 56, configured to measure the proportion of CO2 relative to the total volume of circulating gas and the proportion of CH4 circulating during the phase to fill the drying module C1, C2 with CO2, and thus to check the CO2 saturation throughout the the drying module C1, C2 drying circuit.

According to one embodiment, the drying module C1, C2 according to the invention also comprises an additional discharge outlet connected to the drying chamber 1 and comprising at least one fan 44 followed by an outlet solenoid valve 703 as well as a sensor to measure the circulating gas flow rate and temperature 51, and configured to allow the flow rate and temperature of the gas mixture to be measured when the drying chamber 1 is emptied.

By way of a non-limiting example, the fan-type 43, 44 circulation resources 4 of the additional discharge outlet and of the discharge circuit are of the medium-pressure, single-suction centrifugal fan type with sheet steel casing and impeller, said fan comprising an impeller with forward-inclined blades made of galvanised sheet steel, the fan 51 being capable of withstanding a maximum temperature of the air or CO2 to be transported of −20° C. to 250° C.

The drying module C1, C2 also incorporates a computerised control system 6 comprising an application programming interface (API). The application programming interface can be used on the one hand to manage the sending of set points to each of the installation components and, on the other hand, to integrate the data received by the different metrology resources 5, in order to adjust the set points sent to the installation components.

The computerised control system 6 is configured to control the supply resources 3, circulation resources 4, heating resources 2 and recycling resources 600 according to programmes, set point values and drying times appropriate to the required quality of the dried wood, and processing resources to measure, compare and readjust the operating parameters to the set point values if drifts occur.

In practice, the computerised control system 6 is equipped with an application programming interface (API) configured to:
Acquire metrology data and parameters of the wood to be dried by measuring the metrology resources 5;
Activate the CO2 supply resources 3 configured to saturate the drying chamber 1 with CO2;
Check that the CO2 saturation in the circulating gas mixture is sufficient to start a drying cycle by checking the CO2/CH4 measuring resources 56 in the extraction duct;
Activate the heating resources 2 to adjust the humidity of the wood by heating when a sufficient measured CO2 saturation is reached.
If the humidity of the wood exceeds 30%, heat with a temperature limit according to a first set point temperature T1, according to a selected temperature gradient G1 in order to extract the free water from the wood to be dried and activate the circulation resources 203a, 203b;
If the humidity of the wood is less than 30%, heat with a temperature limit according to a first set point temperature T2, according to a selected temperature gradient G2 in order to extract the bound water from the wood to be dried and activate the circulation resources 203a, 203b.
stabilise the temperature of the CO2 circulating in the drying chamber 1 in a first phase when a humidity of less than or equal to 30% is measured, activate the recycling resources 600 and increase the temperature of the CO2 circulating in the drying chamber 1 in a second phase until the measured humidity of the wood reaches a chosen intermediate target value Hi, the heating resource 2 being activated so that reheating is carried out with a limit temperature defined by a second set point temperature T2 of 120° C. according to a selected temperature gradient G2, and depending on the specific drying profile of the wood to be dried allowing the bound water to be extracted from the wood to be dried;
Deactivate the recycling resources 600 and modulate the heating resource 2 activity to reduce the heating chamber 1 temperature in a first phase, to a third stabilisation set point temperature T3 selected according to a temperature gradient G3, when the average humidity of the wood measured using the wood humidity measurement resources 54 reaches the selected intermediate target value Hi, unless one of the measured humidity values of the wood is greater than Hi+1%, said set point temperature T3 being maintained for a selected period of time until the measured humidity value of the wood greater than Hi+1% is stable and within a range of values less than Hi+1%;
Deactivate the heating resources 2 to reduce the heating chamber 1 temperature in a second phase, when the measured average humidity of the wood reaches the final target humidity value Hc,
The set point temperatures T1 and T2 are temperature limits that each drying module C1, C2 may not exceed during these phases.

In addition, each transition from one step to another is only dependent on the humidity target that applies to the current step.

In practice, the selected value range HX is defined as a selected humidity value plus or minus 2%.

In practice, the set point temperature T2 is less than or equal to 120° C.

According to one embodiment of the invention, the computerised control system is also configured to allow control of the dehumidification of the CO2 which is carried out depending on a minimum (20%) and maximum (100%) value for the humidity of the atmosphere in the drying chamber 1. This phase is continuous, regardless of the initial humidity of the wood.

In practice, during drying, if the pressure measurement sensor 55 in the drying chamber 1 detects a pressure of less than 15% of atmospheric pressure for a specified period, the computerised control system 6 opens the solenoid valve 701 of the CO2 supply resource 3 so as to inject fresh CO2. The drying module C1, C2 furthermore comprises at least one environment sensor placed outside said module and capable of recording the temperature and humidity in the environment surrounding said drying module.

In practice, the drying module C1, C2 furthermore comprises an energy consumption meter.

The computerised control system 6 also allows the monitoring, measurement and recording of all the metrology values measured in a table (including energy consumption), as well as emergency procedures (shutdown without resumption of drying or with resumption of drying).

In addition, any examples of resources used are only specific illustrations of resources that can be used for embodiment of the invention. The Person skilled in the art will understand that these examples are not limiting and are not restricted to the examples mentioned, but extend to any example of resources, the implementation of which results in the same technical effect.

1. Installation for processing CO2 from a high-flow CO2 source, with a flow rate greater than 40 Nm3/h, comprising:
at least one CO2 distribution system having a supply circuit comprising an inlet end connected to the high-flow CO2 source to collect and store the CO2 from the CO2 source, and an outlet end;
drying resources in a CO2 atmosphere connected to the CO2 distribution system and configured to process said CO2 thus distributed during a wood drying operation; wherein the CO2 distribution system further comprises storage resources connected, on the one hand, to the outlet end of the supply circuit and, on the other hand, to the CO2 atmosphere drying resource, said storage resource being configured to temporarily store the CO2 coming from the high flow CO2 source for subsequent processing of said CO2.

2. Processing installation according to claim 1, wherein the drying resources in a CO2 atmosphere comprise at least two drying modules configured to sequester the used CO2 in wood.

3. Processing installation according to claim 1, wherein the CO2 storage resources comprise at least one buffer tank configured to temporarily store the CO2 coming from the high-flow CO2 source by supply through a supply solenoid valve and serving as a secondary CO2 supply source to supply the drying modules in a CO2 atmosphere or any other CO2 use module.

4. Processing installation according to claim 1, wherein the CO2 distribution system further comprises booster resources connected to the outlet of the high-flow CO2 source configured to allow the collection of CO2 from the high-flow CO2 source, control the pressure and flow rate of the CO2 in the supply circuit.

5. Processing installation according to claim 3, wherein the CO2 distribution system additionally comprises pressure sensor resources placed at the outlet of the high-flow CO2 source and upstream of a solenoid valve supplying the buffer tank.

6. Processing installation according to claim 1, wherein the CO2 distribution system further comprises gas flow measurement resources configured to measure and record the flow rate of the CO2 circulating in the supply circuit.

7. Processing installation according to claim 1, wherein the distribution system further comprises CO2/CH4 measurement resources, configured to measure the proportion of CO2 or CH4 relative to the overall flow of gas introduced into the system.

8. Processing installation according to claim 4, wherein the booster resources allow interfacing with the high-flow CO2 supply source and the creation, during a CO2 drawing off phase, of a flow speed in the supply conduit of the circulating CO2 of between 1 and 15 metres per second.

9. Processing installation according to claim 4, wherein the booster resources provide a pressure of between 0 and −80 mbar during the CO2 drawing off phases.

10. Processing installation according to claim 2, wherein each CO2 atmosphere drying module comprises:
a drying chamber comprising at least one hollow cylindrical drying tube of suitable diameter and length for drying wood of selected dimensions,
CO2 supply resources to inject gas into the drying chamber
circulation resources;
heating resources to heat the circulating CO2;
gas circulation resources to force the circulation of CO2 from one end to the other of the drying chamber in a closed circuit in the direction of the length of the chamber, with injection and extraction into the cylinder positioned at the ends of the cylindrical drying chamber and renewal of the atmosphere inside the drying chamber, and comprising a flow reversal module configured to allow the circulation of CO2 in a first direction of circulation in the drying chamber and in a second direction of circulation opposite to the first direction, and able to even out the thermal distribution in said drying chamber;
CO2 recycling resources configured to allow the separation of the water vapour and CO2 gas present in the atmosphere extracted from the chamber during drying;
metrology resources to measure variations in the physical parameters of the drying plant during heating;
CO2 supply resources; and
a computerised control system to control the supply resources, circulation resources, heating resources and recycling resources according to programmes, set point values and drying times appropriate to the required quality of dried wood, and processing resources to measure, compare and readjust the operating parameters to the set point values if drifts occur.

11. Processing installation according to claim 10, wherein the computerised control system is equipped with an application programming interface configured to:
Acquire metrology data and parameters of the wood to be dried by measuring the metrology resources;
Activate the CO2 supply resources configured to saturate the drying chamber with CO2;
Check that the CO2 saturation in the circulating gas mixture is sufficient to start a drying cycle by checking the CO2/CH4 measuring resources in the extraction duct;
Activate heating resources to adjust the humidity of the wood by heating when a sufficient measured CO2 saturation is reached;
If the humidity of the wood exceeds 30%, heat with a temperature limit according to a first set point temperature T1, according to a selected temperature gradient G1 in order to extract the free water from the wood to be dried and activate the circulation resources;
If the humidity of the wood is less than 30%, heat with a temperature limit according to a first set point temperature T2, according to a selected temperature gradient G2 in order to extract the bound water from the wood to be dried and activate the circulation resources;
stabilise the temperature of the CO2 circulating in the drying chamber in a first phase when a humidity of less than or equal to 30% is measured, activate the recycling resources and increase the temperature of the CO2 circulating in the drying chamber in a second phase until the measured humidity of the wood reaches a selected intermediate target value Hi, the heating resources being activated so that reheating is carried out with a limit temperature defined by a second set point temperature T2 of 120 ° C. according to a selected temperature gradient G2, and depending on the specific drying profile of the wood to be dried allowing the bound water to be extracted from the wood to be dried;
Deactivate the recycling resources and modulate the heating resource activity to reduce the heating chamber temperature in a first phase, to a third stabilisation set point temperature T3 selected according to a temperature gradient G3, when the average humidity of the wood measured using the wood humidity measurement resources reaches the selected intermediate target value Hi, unless one of the measured humidity values of the wood is greater than Hi+1%, said set point temperature T3 being maintained for a selected period of time until the measured humidity value of the wood greater than Hi+1% is stable and within a range of values less than Hi+1%;
Deactivate the heating resources to reduce the heating chamber temperature in a second phase, when the measured average humidity of the wood reaches the final target humidity value Hc.

12. Processing installation according to claim 10, wherein the CO2 recycling resources are of the heat exchanger type comprising at least one cooling battery, configured to gradually extract the water from the gas mixture, each cooling battery being capable of extracting a selected percentage of water from said gas mixture.

13. Processing installation according to claim 12, wherein the CO2 recycling resources are of the heat exchanger type comprising at least one cooling battery configured to gradually extract water from the gas mixture, each cooling battery being capable of extracting a selected percentage of water from said gas mixture.

14. Processing installation according to claim 1, further comprising an additional electric power supply module of the photovoltaic roof type.

15. Processing installation according to claim 10, wherein for each drying module in a CO2 atmosphere, the drying chamber comprises a minimum volume of 10 m3 saturable with CO2.
